(19) United States
(12) Patent Application Publication
(10) Pub. No.: US 2002/0059258 A1
(43) Pub. Date: May 16, 2002

(54) METHOD AND APPARATUS FOR RETRIEVING AND DISPLAYING CONSUMER INTEREST DATA FROM THE INTERNET

(76) Inventor: JAMES F. KIRKPATRICK, MILFORD, OH (US)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(21) Appl. No.: 09/235,108

(22) Filed: Jan. 21, 1999

(51) Int. Cl. G06F 7/00

(52) U.S. Cl. 707/100

(57) ABSTRACT

The system and method of the present invention retrieves data on a date delimited and/or periodic basis from an Internet search engine and displays predefined interest trends associated with the data. The Internet search engine preferably includes a database containing a plurality of search terms associated with a plurality of web page addresses, and/or a database containing a plurality of previously issued search queries. Preferably, the database is queried with a specific search term at different points in time or a series of queries is delimited by date. Subsequently, the number of web pages associated with the search term, the total number of hits the web pages received, and/or the number of times Internet users submitted queries containing the search term, is displayed.

### BACKGROUND OF THE INVENTION

Networked environments such as the Internet and the World Wide Web allow people using local network devices to request information from remote network devices. Typically the local network device is a personal computer (PC) executing client software (e.g., a web browser); the remote network device is typically a web site; and the network is the Internet. In order to make a request, an Internet user must know the address of the desired information. Often, the user will issue a query to an Internet search engine in order to determine an address. Typically, the query consists of a text string of search terms characterizing the desired information (e.g., “laundry & detergent & whitener”).

When a user issues a query to an Internet search engine, a database is consulted to produce a list of Internet addresses related to the terms of the query. In order to create these databases, Internet search engines typically use autonomous software agents (spiders) to systematically traverse web pages by following embedded hyperlinks. As the software agent retrieves web pages, it gathers information related to each web page, such as its address (or other unique identifier), its title, its contents, the date it was created, and the date it was modified. All of this information is then stored in the database for subsequent retrieval.

In order to increase advertising revenue associated with the number of visitors a web site serves, web site proprietors attempt to produce web pages that do (or will in the future) have a high interest level. Typically, decisions about what content to provide are made using traditional marketing techniques such as surveys, trial and error, and gut instinct. However, these techniques have certain drawbacks. They are inaccurate, inefficient, and expensive. Further, because people's interests change, they must be repeated, thereby compounding the problems.

### SUMMARY OF THE INVENTION

The present invention is directed to a computing device and program for electronically gathering and displaying consumer interest data in order to reveal consumer interest trends. The method and apparatus provide increased accuracy and efficiency in tracking changing consumer interests.

In one aspect, the invention is directed to a method and apparatus for electronically gathering consumer interest data from the Internet and displaying the data on an output device to reveal consumer interest trends. The system receives a search term from a user input device identifying a consumer item the user is interested in. The system also receives an overall date range identifying a time period over which to limit the display of consumer product interest data and/or a time step value. In one embodiment the search terms and date ranges are sent to an Internet search engine as date delimited queries. In another embodiment, the system waits a predetermined period of time between the queries. Subsequently, the system electronically displays data indicative of a consumer interest level associated with each of the queries on an output device such as a display.

These and other features and advantages of the present invention will be apparent to those of ordinary skill in the art in view of the detailed description of the preferred embodiment which is made with reference to the drawings, a brief description of which is provided below.

### BRIEF DESCRIPTION OF THE DRAWINGS

FIG. 1 is a block diagram of a computer network in which the present invention is utilized;

FIG. 2 is a more detailed block diagram of the computing device of FIG. 1;

FIG. 3A is an exemplary table displaying interest data;

FIG. 3B is an exemplary line graph displaying interest data;

FIG. 3C is an exemplary pie chart displaying interest data;

FIG. 4 is a flow chart of a program that can be implemented by the computing device of FIG. 2 to gather and display consumer interest data using date delimited queries;

FIG. 5 is a flow chart of a program that can be implemented by the computing device of FIG. 2 to gather and display consumer interest data using periodic queries;

FIG. 6 is a flow chart of a program that can be implemented by the computing device of FIG. 2 to gather and display consumer interest data using periodic meta-queries; and,

FIG. 7 is a flow chart of a program that can be implemented by the computing device of FIG. 2 to display consumer interest data and initiate an alarm if a predetermined threshold is crossed.

### DETAILED DESCRIPTION OF THE PREFERRED EMBODIMENTS

In general, the system and method of the present invention retrieves data on a date delimited and/or periodic basis from an Internet search engine and displays predefined interest trends associated with the data. The Internet is a nationwide network that includes, but is not limited to, the World Wide Web. An Internet search engine preferably includes a database containing a plurality of search terms associated with a plurality of web page addresses, and/or a database containing a plurality of previously issued search queries. Preferably, the database is queried with a specific search term at different points in time or a series of queries is delimited by date. Subsequently, the number of web pages associated with the search term, the total number of hits those web pages received, and/or the number of times Internet users submitted queries containing the search term, is displayed.

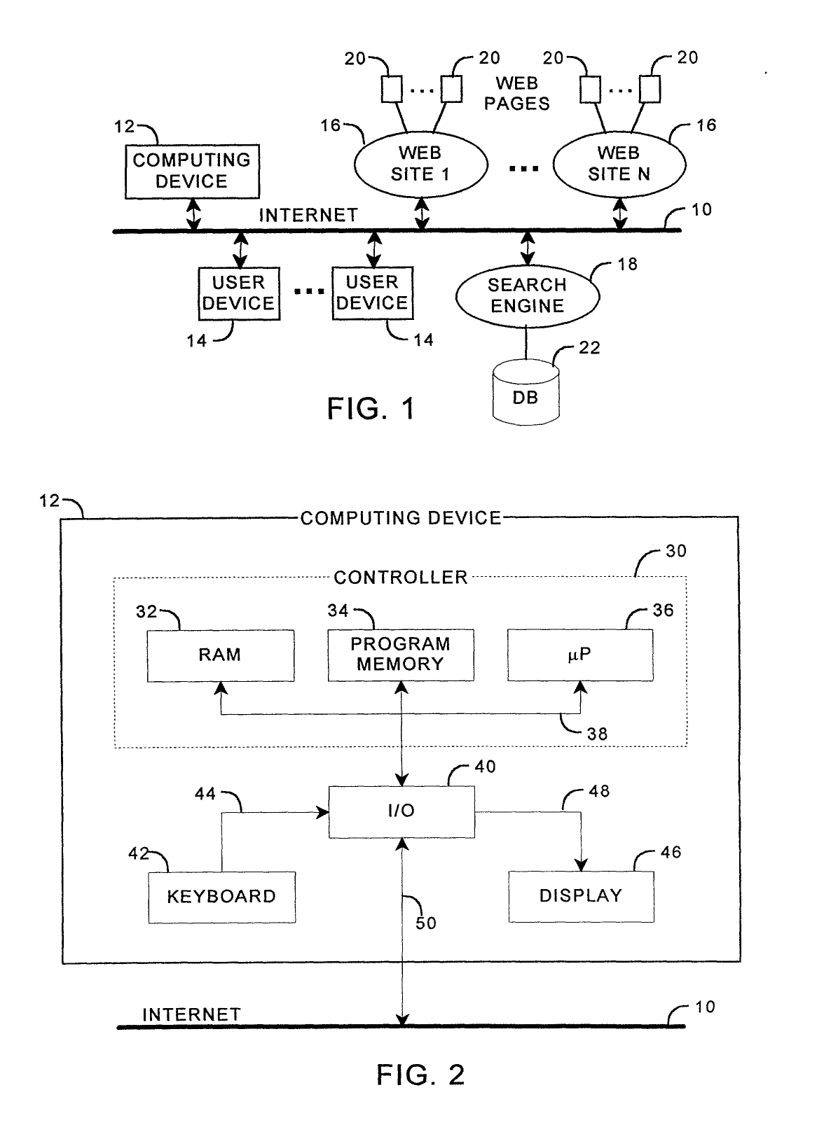

A block diagram of a computer network 10 in which the present invention is utilized is illustrated in FIG. 1. A computing device 12, a plurality of user devices 14, a plurality of web sites 16, and a search engine 18 are coupled to the network 10 in a known manner. Upon request, each web site 16 serves data related to one or more web pages 20 such as text, graphics, and hypertext markup language (HTML) files to other devices 12, 14, 18 over the network 10. However, a requesting device 12, 14, 18 typically must determine the address of the desired web page 20 in order to direct the request. Due to the fact that web pages 20 are added and deleted with some frequency, address determination can be cumbersome.

In order to facilitate address determination, the search engine 18 may periodically request known web pages 20 (i.e., web pages 20 listed by address in a previously compiled local database 22) from the web sites 16 and traverse hyperlinks contained in the web pages 20 to determine new web pages 20 (i.e., a web spider). The search engine 18 may delete web page addresses from the database 22 that no longer exist and include the addresses of new web pages 20. Further, the search engine 18 may store other information associated with each web page 20 such as the title of the web page 20, the date the web page was created, the date the web page was modified (if any), key terms describing the web page 20, and/or the full text of the web page 20. Subsequently, an operator of a user device 14 may query the search engine 18 in order to determine an appropriate web page addresses.

A more detailed diagram of the computing device 12, is illustrated in FIG. 2. A controller 30 in the computing device 12 preferably includes a random-access memory (RAM) 32, a program memory 34, which may be in the form of a read-only memory (ROM), and a microprocessor (æP)36, all of which may be interconnected by an address/data bus 38. Preferably, the program memory 34 electronically stores a computer program that implements all or part of the method described below, and the program is preferably executed by the μP 36. Some of the steps described in the method below may be performed manually or without the use of the computing device 12.

A transmitter in the form of a conventional input/output (I/O) circuit 40 or modem typically couples the controller 30 to the network 10. A keyboard 42 may be connected to the I/O circuit 40 via a line 44 for entering data and commands into the controller 30. Further, a visual display 46, such as a cathode ray tube (CRT) or liquid crystal display (LCD), may be connected to the I/O circuit 40 to receive data via a line 48 to generate visual displays of data generated during operation of the computing device 12. The visual displays may include the data set forth in various diagrams shown in the drawings and described in detail below. The computing device 12 may also be connected to the network 10 via a line 50 connected to the I/O circuit 40 to send and receive data to and from the search engine 18 and/or the web sites 16.

Once the desired interest data has been collected it is preferably displayed. The interest data may include the number of web pages 20 associated with one or more search terms, the total number of hits web pages 20 associated with one or more search terms received, and/or the number of times Internet users submitted queries containing the search term. Many formats for displaying data could be used. For example, a table, a line graph, or a pie chart could be used.

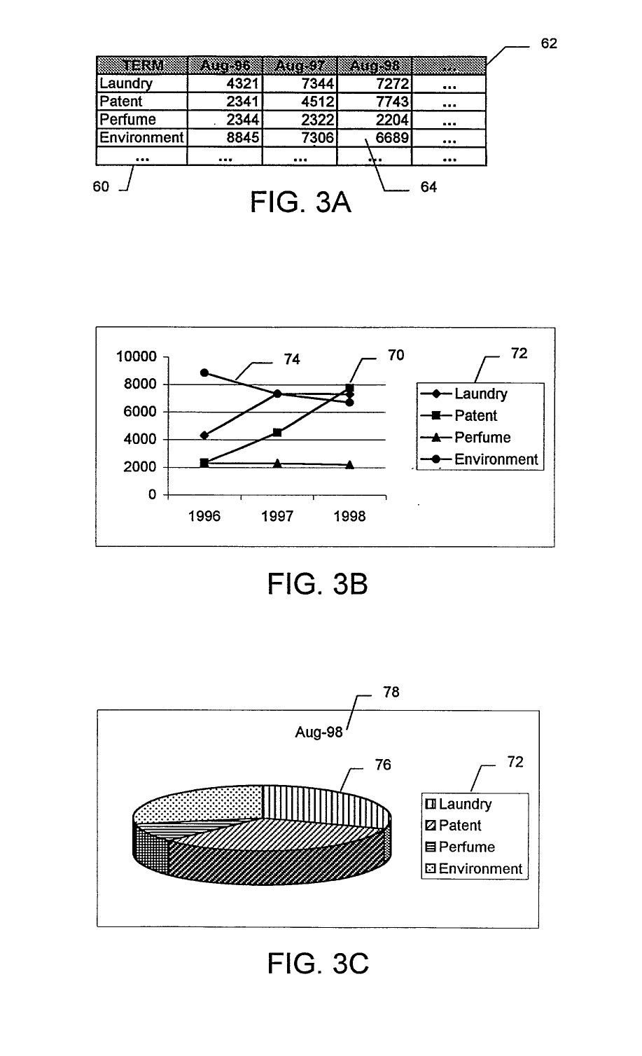

An exemplary table displaying interest data is illustrated in FIG. 3A. Preferably, a plurality of search terms, a plurality of date ranges, and a number representing an interest level are show. In this example, the left most column 60 lists a plurality of search terms (Laundry, Patent, Perfume, Environment, etc.) under the heading “TERM”. The topmost row 62 lists the plurality of date ranges (August 1996, August 1997, August 1998, etc.), and each box 64 underneath and date range contains a number representing an interest level (e.g., number of pages, hits, or queries). Persons of ordinary skill in the art will readily appreciate that many other formats for a table are well known and fall within the scope of the present invention.

An exemplary line graph displaying the same interest data from the previous example is illustrated in FIG. 3B. Again, a plurality of search terms, a plurality of date ranges, and a number representing an interest level are shown. The x-axis lists the date ranges (1996, 1997, 1998, etc.). The y-axis shows a scale of numbers representing increasing interest levels (0-10000), and the data points 70 associated with each search term (Laundry, Patent, Perfume, Environment, etc.) are plotted in the chart with a legend 72 to differentiate one search term from another. Preferably, the data points 70 are connected by a line 74.

An exemplary pie chart showing a plurality of search terms represented by graphic elements 76 proportionately sized by interest level is illustrated in FIG. 3C. Again, a legend 72 is provided to differentiate one search term from another. Only one of the date ranges (August 1998) 78 is displayed, however a sliding scale may be employed to animate the pie chart over the plurality of date ranges. For example, by moving a scroll bar (not shown) to the right the date range 78 could be updated to progressively later dates. Accordingly, the size of the graphic elements 76 would change to reflect the relative interest levels associated with that date range 78.

Several different methods may be employed by the computing device 12 to obtain consumer interest data. For example, a date delimited query may be used to gather and display consumer interest data for date ranges in the past, and/or a periodic query may be used to keep existing trend date current. Further, different types of consumer interest data may be collected. For example, the number of web pages 20 associated with one or more search terms may be collected and displayed. Similarly, the total number of hits received by a group of web pages 20 associated with one or more search terms may be collected and displayed, or the number of times Internet users submitted queries containing one or more search terms may be collected and displayed.

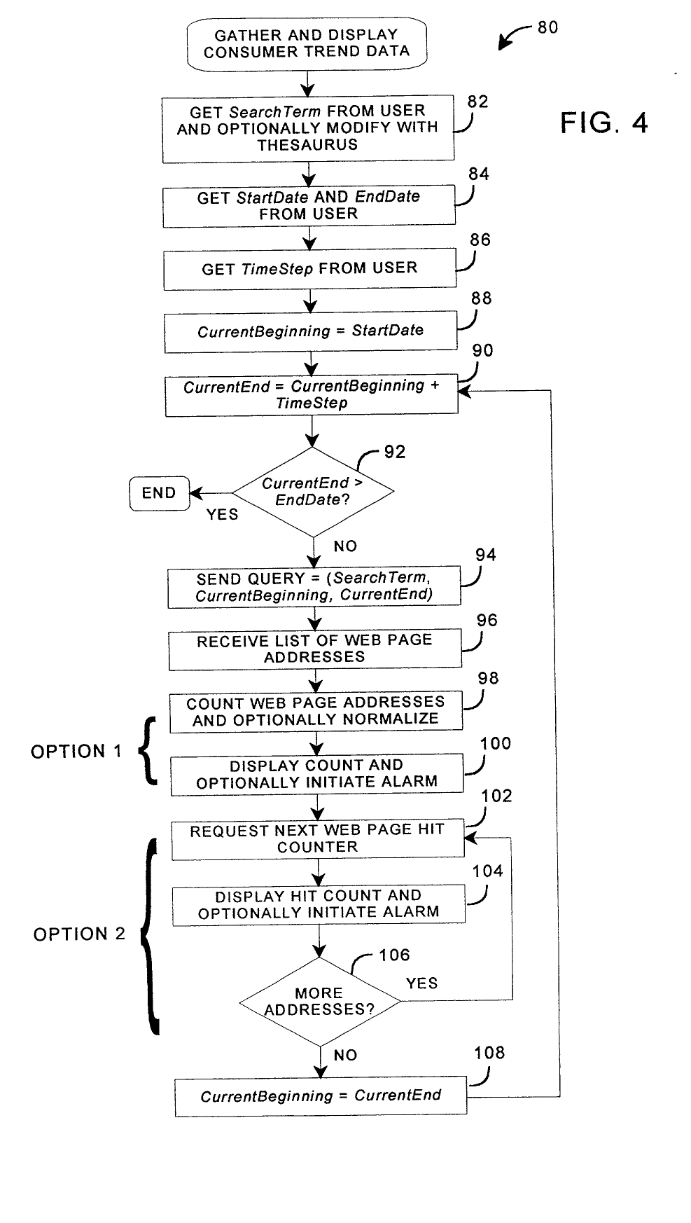

A flow chart of a computer program 80 that can be implemented by the computing device 12 to gather and display consumer interest data using date delimited queries in accordance with the teachings of the present invention is illustrated in FIG. 4. When the program 80 is initiated, the controller 30 preferably receives inputs from the keyboard 42 (or other input device) specifying a series of date ranges and one or more search terms. Each search term indicates a consumer interest item for which the controller 30 is to collect interest data, and the data ranges indicate the time period over which to collect the interest data. Subsequently, the controller 30 may collect interest data (e.g., number of web pages 20, number of hits) associated with each search term for the specified date ranges and display the results on the display 46.

The program 80 preferably begins by receiving a search term, a start date, an end date, and a time step from a user via an input device at steps 82, 84, and 86 respectively. For example, a person may enter “SearchTerm=Laundry, StartDate=August 1997, EndDate=August 1998, TimeStep=1 Month” via the keyboard 42 to indicate that interest data related to laundry should be collected and displayed on a monthly basis for the year extending from August 1997 to August 1998. Persons of ordinary skill in the art will readily appreciate that many different input devices and input formats are possible. For example, a mouse may be used to select a search term from a menu and/or to select a date range from a calendar. In an alternate embodiment, the controller 30 may modify a list of search terms by consulting a thesaurus database stored in memory or prompting the user for alternative terms. The thesaurus database preferably comprises a list of terms, each term mapping to a plurality of similar terms to be used in the alternative. The thesaurus database may be stored locally in RAM 32 or program memory 34, external and accessible via the I/O circuit 40, and/or available over the network 10.

The program 80 preferably continues by recording the beginning of the current date range by setting a variable in RAM 32 at step 88 equal to the start date that was entered in step 84 (e.g., CurrentBeginning=August 1997). Similarly, at step 90, the program 80 may set the end of the current date range by setting a variable in RAM 32 equal to the current beginning plus the time step value that was entered at step 86 (e.g., CurrentEnd=August 1997+1 Month=September 1997). As the program 80 iterates through each of the date ranges, it preferably detects when it has completed by checking if the end of the current date range is greater than the overall date range end date at step 92 (e.g., if CurrentEnd>EndDate). So far in this example, the answer is no because CurrentEnd=September 1997, EndDate=August 1998, and September 1997 is not greater than August 1998. When the condition at step 92 does become true the program 80 may terminate.

If the condition at step 92 is not true (i.e., not done yet), the program 80 preferably sends a query message over the network 10 to the search engine 18 via the I/O device 40 at step 94. The query may include the search term, the beginning of the current date range, and the end of the current date range. The search engine 18 then retrieves a list of web page addresses that existed during that date range from its database 22 and sends them back to the computing device 12 where they are received by the program 80 at step 96 in a known manner.

Once received at step 96, web page addresses may be converted into numerical data indicative of a consumer interest level in one or both of at least two ways (option 1 and option 2 of FIG. 4). First, the web page addresses may be counted and optionally normalized at step 98. Normalization includes dividing the number of addresses by a normalizing factor indicative of the growth rate of the Internet. For example, if independently acquired data indicates that the overall usage of the Internet has increased by 10% from one date range to the next (e.g., from August 1997 to September 1997), and the number of web sites related to laundry has increased from 7344 to 8000, the normalized version of 8000 would be 7272 (i.e., 8000/1.1). In other words, the increase in web pages 20 actually reflected a decrease in interest level. Subsequently, the number of web pages 20, with or without normalization, may be graphically displayed at step 100 as described in detail below. Further, an alarm may be initiated at step 100 if the number of web pages 20 exceeds some predetermined threshold as described in detail below.

The second option includes retrieving a hit counter from each of the web sites 16 identified by the search engine 18. Each web page 20 hit counter is preferably retrieved at step 102 by sending a request message to the appropriate web site 16 or querying the search engine 18 for hit count data. As described in detail above, the data may be normalized to reflect increases or decreases in interest levels without including growth attributed to the Internet in general. Subsequently, the retrieved hit count and/or a cumulative hit count (i.e., total of all the hit counts retrieved associated with a particular search term) may be graphically displayed at step 104 as described in detail below. Further, an alarm may be initiated at step 104 if a hit count or a cumulative hit count exceeds some predetermined threshold as described in detail below. This process (steps 102 and 104) is repeated if the controller 30 determines at step 106 that there are more web pages 20 from which to retrieve hit counters. When all of the interest data for the current date range has been collected, the controller 30 may set the beginning of the current date range equal to the end of the just processed date range at step 108 and loop back to step 90 to repeat the process for the next date range.

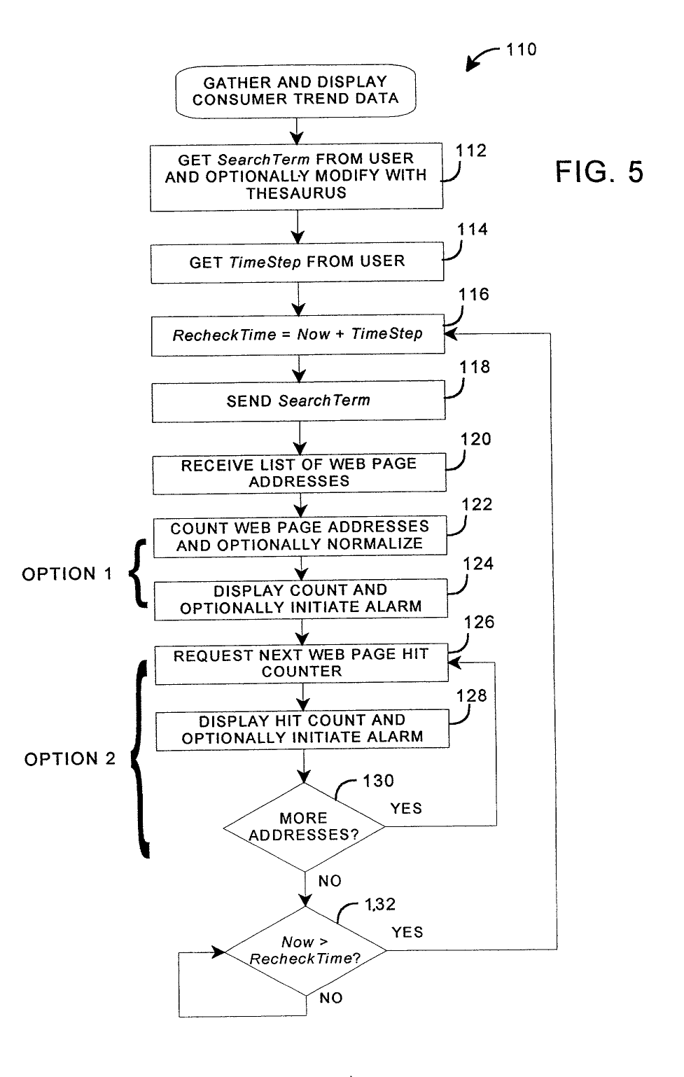

A flow chart of a computer program 110 that can be implemented by the computing device 12 to gather and display consumer interest data using periodic queries in accordance with the teachings of the present invention is illustrated in FIG. 5. Preferably, the programmed steps are performed by the controller 30. Once the program 110 is initiated the controller 30 preferably receives inputs from the keyboard 42 (or other input device) specifying one or more search terms. Each search term may indicate a consumer interest item for which the controller 30 is to periodically collect interest data. Subsequently, the controller 30 may begin periodically collecting interest data (e.g., number of web pages 20, number of hits) associated with each search term and display the results on the display 46.

The program 110 preferably begins by receiving a search term and a time step from a user via an input device at steps 112 and 114 respectively. For example, a person may enter “SearchTerm=Laundry, TimeStep=1 Month” via the keyboard 42 to indicate that interest data related to laundry should be collected and displayed on a monthly basis going forward. Persons of ordinary skill in the art will readily appreciate that many different input devices and input formats are possible as discussed above. Further, a thesaurus database may be used to modify the search term as discussed above.

The program 110 preferably continues by recording a time in the future when the interest data should be rechecked by setting a variable in RAM 32 at step 116 equal to the current time plus the time step that was entered in step 114 (e.g., RecheckTime=August 1998+1 month=September 1998). Subsequently, the program 110 may send a query message over the network 10 to the search engine 18 via the I/O device 40 at step 118. Preferably, the query consists primarily of the search term (plus any protocol overhead that may be required for the particular type of network used). The search engine 18 then retrieves a list of web page addresses from its database 22 and sends them back to the computing device 12 where they are received by the program 110 at step 120 in a known manner.

Once received at step 120, web page addresses may be converted into numerical data indicative of a consumer interest level in one or both of at least two ways (option 1 and option 2 of FIG. 5) as described in detail above. First, the web page addresses may be counted and optionally normalized at step 122, and then, the number of web pages 20, with or without normalization, may be graphically displayed at step 124. Further, an alarm may be initiated at step 124 if the number of web pages 20 exceeds some predetermined threshold as described in detail below.

The second option includes retrieving a hit counter from each of the web sites 16 identified by the search engine 18. Each web page 20 hit counter is preferably retrieved at step 126 by sending a request message to the appropriate web site 16 or querying the search engine 18 for hit count data. As described in detail above, the data may be normalized to reflect increase or decreases in interest levels without including growth attributed to the Internet in general. Subsequently, the retrieved hit count and/or a cumulative hit count may be graphically displayed at step 128 as described in detail below. Again, an alarm may be initiated at step 128 if a hit count or a cumulative hit count exceeds some predetermined threshold as described in detail below. This process (steps 126 and 128) may be repeated if the controller 30 determines at step 130 that there are more web pages 20 from which to retrieve hit counters. When all of the interest data for the current query has been collected and displayed, the controller 30 waits until the current time exceeds the recheck time at step 132 (e.g., waits one month). At that time the program 110 loops back to step 116 to again collect and display interest data.

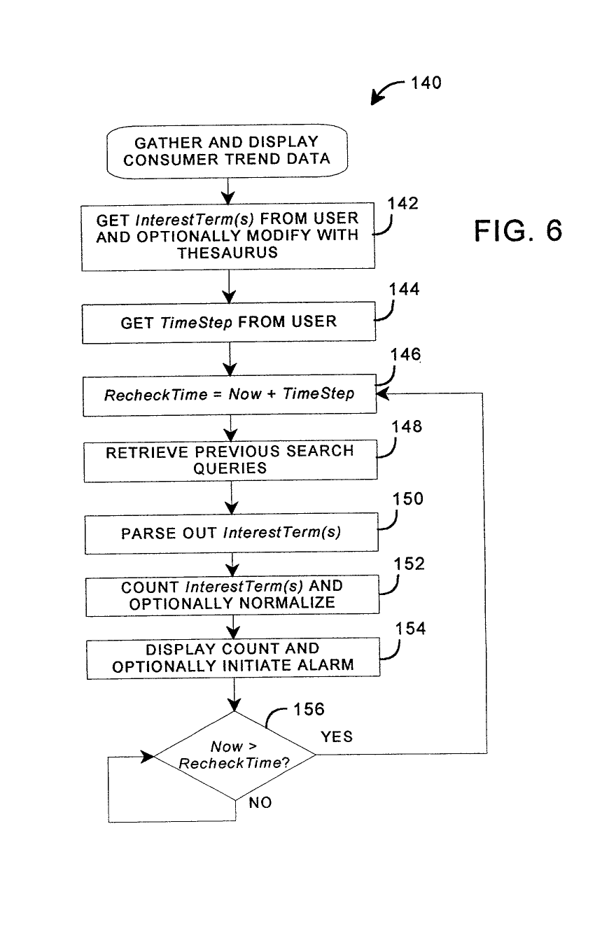

A flow chart of a computer program 140 that can be implemented by the computing device 12 to gather and display consumer interest data using periodic meta-queries (queries about queries) in accordance with the teachings of the present invention is illustrated in FIG. 6. Preferably, the programmed steps are performed by the controller 30. Once the program 140 is initiated the controller 30 preferably receives inputs from the keyboard 42 (or other input device) specifying one or more interest terms. Each interest term may indicate a consumer interest item for which the controller 30 is to periodically collect interest data by querying the search engine 18 about other people's search terms. Subsequently, the controller 30 may periodically collect interest data (e.g., the number of times Internet users submitted queries containing a particular interest term) associated with each interest term and display the results on the display 46.

The program 140 preferably begins by receiving an interest term and a time step from a user via an input device at steps 142 and 144 respectively. For example, a person may enter “InterestTerm=Laundry, TimeStep=1 month” via the keyboard 42 to indicate that interest data related to laundry should be collected and displayed on a monthly basis going forward. Persons of ordinary skill in the art will readily appreciate that many different input devices and input formats are possible as discussed above. Further, a thesaurus database may be used to modify the search term as discussed above.

The program 140 preferably continues by recording a time in the future when the interest data should be rechecked by setting a variable in RAM 32 at step 146 equal to the current time plus the time step that was entered in step 144 (e.g., RecheckTime=August 1998+1 month=September 1998). Subsequently, the program 140 may retrieve a set of queries, previously issued to the search engine 18 by user devices 14, from the search engine 18 via the I/O device 40 and the network 10 at step 148. The set of queries may be the entire set, a subset based on time (e.g., all queries from the previous month), or a subset based on an interest term (e.g., all queries containing the word laundry).

Once the queries are received by the computing device 12, the controller 30 may parse the queries for the interest term. Parsing may be performed in any known manner. For example, the controller may scan each of the queries for exact text matches or partial text matches to the interest term. Or, the controller 30 may scan each of the queries for exact or partial text matches to synonyms of the interest term. Alternatively, the controller 30 may separate the query into a plurality of terms based on predetermined text delimiters, such as punctuation marks and space characters, and then modify the interest term to be consistent with a term from the plurality with a high frequency of occurrence.

One of at least two accounting schemes may be used by the controller 30 at step 152 when counting interest terms. Each instance of the interest term may be accumulated into a running total, or each query containing at least one instance of the interest term may be accumulated into a running total. In other words, the count may reflect the number of interest terms or the number of queries containing the interest term. As described in detail above, the count may be normalized at step 152 to reflect increases or decreases in interest levels without including growth attributed to the Internet in general.

Subsequently, the count, with or without normalization, may be graphically displayed at step 154 as described in detail below. Further, an alarm may be initiated at step 154 if the count exceeds some predetermined threshold, also described in detail below. After all of the interest data for the current interest term has been collected and displayed, the controller 30 waits until the current time exceeds the recheck time at step 156 (e.g., waits one month). At that time the program 110 loops back to step 146 to again collect and display interest data.

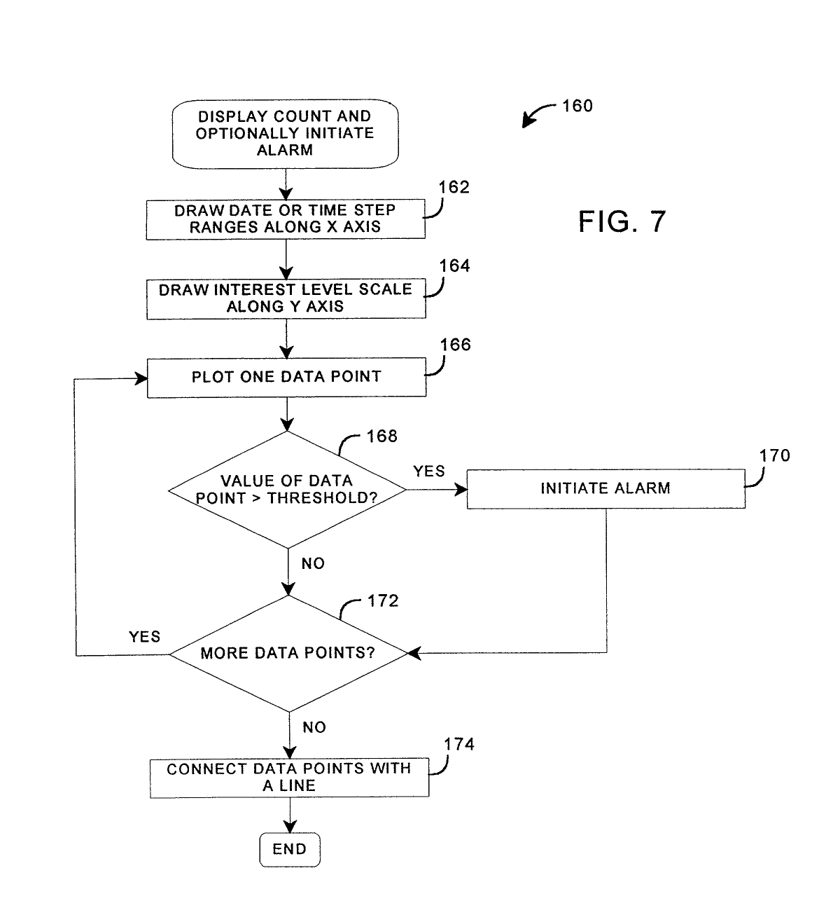

A flow chart of a computer program 160 that can be implemented by the computing device 12 to display consumer interest data, and optionally initiate an alarm if a predetermined threshold is crossed, in accordance with the teachings of the present invention is illustrated in FIG. 7. Although this program displays data in a format consistent with the line graph of FIG. 3B, persons of ordinary skill in the art will readily appreciate that many other display formats conveying data in a graphical manner are well known. Preferably, the programmed steps are performed by the controller 30. Once the program 160 is initiated the controller 30 may draw date ranges and/or time step values along an x-axis at step 162 in a known manner. Similarly, the program 160 may draw an interest level scale along a y-axis at step 164. Preferably, the x-axis and the y-axis are scaled to include all of the data to be displayed. The interest data is then plotted between the axes to reveal trends.

As each data point 70 is plotted at step 166, the controller 30 may test the value of the data point to determine if it exceeds a predetermined threshold at step 168. For example, a user of the present invention may want to be alerted if the number of web pages related to laundry goes above 8000 or below 6000. If the controller 30 does determine that a threshold has been crossed at step 168, an alarm may be initiated at step 170. The alarm may be anything that notifies a user. For example, a special symbol such as an arrow may be plotted on the display. Or, a different color may be used for the data point 70 and/or line 74 when a threshold is crossed. Alternatively, an audible and/or visual message may be produced by the computing device 12. Still further, an e-mail or pager message may be generated.

After each data point 70 is plotted and checked against any thresholds, the controller 30 determines if there are any more data points 70 to be plotted at step 172. If the controller 30 determines that there are more data points 70, the program loops back to step 166 to plot and check the next data point 70. When all the data points 70 have been plotted, a line 74 connecting data points 70 of the same term may be drawn at step 174 to enhance readability and facilitate trend analysis. Persons of ordinary skill in the art will readily appreciate that the line 74 may be draw after each data point 70 is plotted and that checking the data for threshold crossings may be performed separately from graphically displaying the data points 70.

In summary, persons of ordinary skill in the art will readily appreciate that a method and apparatus for electronically gathering and displaying consumer interest data has been provided. Systems implementing the teachings of the invention can enjoy increased accuracy and efficiency in tracking consumer interest trends.

Modifications and alternative embodiments of the invention will be apparent to those skilled in the art in view of the foregoing description. This description is to be construed as illustrative only, and is for the purpose of teaching those skilled in the art the best mode of carrying out the invention. The details of the structure and method may be varied substantially without departing from the spirit of the invention, and the exclusive use of all modifications which come within the scope of the appended claims is reserved.

What is claimed is:

1. A method for electronically gathering consumer interest data from the Internet and displaying the data on a output device to reveal consumer interest trends, said method comprising the steps of:
receiving a search term from a user input device identifying an interest item;
sending a first query including the search term and a second query including the search term over the Internet to a search engine, wherein the search engine is associated with a database containing web page identifiers; and,
electronically displaying data indicative of an interest level associated with each of the first and second queries on an output device.

2. A method as defined in claim 1, wherein the first and second queries comprise date delimited queries and further comprising the steps of:
receiving an overall date range from the user input device identifying a time period over which to limit the display of interest data;
receiving a time step value from the user input device indicative of a predetermined period of time; and,
determining first and second date ranges from the overall date range and the time step value, wherein the first query is based on the search term and the first date range, and the second query is based on the search term and second date range.

3. A method as defined in claim 2, wherein the displaying step comprises the step of electronically displaying a table showing:
a plurality of search terms;
the first date range;
the number of web page identifiers contained in the database associated
with the first date range;
the second date range; and,
the number of web page identifiers contained in the database associated with the second date range.

4. A method as defined in claim 2, wherein the displaying step comprises the step of electronically displaying a graph showing:
a plurality of date ranges along a first axis;
an interest level scale along a second axis; and,
a line indicative of the interest level for each date range.

5. A method as defined in claim 1, further comprising the step of requesting a web page hit counter from a web site and electronically displaying the number of hits on the output device.

6. A method as defined in claim 1, further comprising the step of dividing the number of addresses contained in the database associated with each of the first and second queries by a normalizing factor indicative of the growth rate of the Internet.

7. A method as defined in claim 1, further comprising the step of modifying the search term based on a synonym retrieved from a thesaurus database.

8. A method as defined in claim 1, further comprising the steps of:
receiving a time step value from the user input device indicative of a predetermined period; and,
waiting the predetermined period of time after sending the first query and before sending the second query.

9. A method as defined in claim 8, further comprising the step of initiating an alarm if the data indicates an interest level that crosses a predetermined threshold value.

10. A method for electronically gathering consumer interest data from the Internet and displaying the data on a output device to reveal consumer interest trends, said method comprising the steps of:
receiving a term identifying an interest item;
retrieving a first plurality of search queries over the Internet from a search engine, wherein the search engine is associated with a database containing queries compiled from a plurality of Internet users;
counting the instances of the term in the first plurality of search queries;
waiting a predetermined period of time;
retrieving a second plurality of search queries over the Internet from the search engine;
counting the instances of the term in the second plurality of search queries; and,
electronically displaying data indicative of the first and second counts on an output device.

11. A method as defined in claim 10, wherein the displaying step comprises the step of electronically displaying:
a plurality of identifying terms;
first and second time step ranges; and,
data indicative of the first and second counts.

12. An apparatus for electronically displaying consumer interest data gathered from the Internet comprising:
a user input device for receiving a search term identifying an interest item, an overall date range identifying a time period over which to limit the display of interest data, and a time step value indicative of a predetermined period of time;
a controller operationally coupled to the user input device, the controller determining a first date range and a second date range from the overall date range and the time step value, the controller generating a first date delimited query based on the query expression and the first date range and a second date delimited query based on the query expression and second date range, the controller determining the number of addresses contained in the database associated with each of the first and second date delimited queries;
a transmitter operatively coupled to the controller, the controller causing the transmitter to send the first and second date delimited queries over the Internet to a search engine associated with a database containing web page addresses; and,
a display device operatively coupled to the controller, the controller causing the display device to display the number of addresses contained in the database associated with each of the first and second date delimited queries.

13. An apparatus as defined in claim 12, wherein the controller is adapted to requesting a web page hit counter from a web site.

14. An apparatus as defined in claim 12, wherein the controller is adapted to dividing the number of addresses contained in the database associated with each of the first and second date delimited queries by a normalizing factor indicative of the growth rate of the Internet.

15. An apparatus as defined in claim 12, wherein the controller is adapted to modifying the search term based on a synonym retrieved from a thesaurus database.

16. An apparatus for electronically displaying consumer product interest data gathered from the Internet comprising:
a user input device for receiving a search term identifying an interest item and a time step value indicative of a predetermined period of time between consumer interest data points;
a controller operatively coupled to the user input device for sending the search term over the Internet to a search engine, wherein the search engine is associated with a precompiled database containing web page addresses, in order to determine a first and second number of web pages in the database associated with the search term, the controller being programmed to wait the predetermined period of time after sending the search term to determine a first number of web pages and before sending the search term to determine a second number of web pages; and,
a display device operatively coupled to the controller for electronically displaying interest data indicative of the first and second number of web pages.

17. An apparatus as defined in claim 16, wherein the controller is adapted to request a web page hit counter from a web site.

18. An apparatus as defined in claim 16, wherein the controller is programmed to divide the number of addresses contained in the database associated with each of the first and second date delimited queries by a normalizing factor indicative of the growth rate of the Internet.

19. An apparatus as defined in claim 16, wherein the controller is adapted to modify the search term based on a synonym retrieved from a thesaurus database.

20. An apparatus as defined in claim 16, wherein the controller is adapted to generate an alarm in response to detecting interest data that exceeds a predetermined threshold value.
